(19) United States
(12) Patent Application Publication
(10) Pub. No.: US 2014/0098332 A1
(43) Pub. Date: Apr. 10, 2014

(54) Displays With Logos and Alignment Marks

(71) Applicant: APPLE INC., Cupertino, CA (US)

(72) Inventors: Kyung Wook Kim, Cupertino, CA (US); Cheng Chen, San Jose, CA (US); Shih Chang Chang, Cupertino, CA (US); Young Bae Park, San Jose, CA (US); John Z. Zhong, Cupertino, CA (US)

(73) Assignee: Apple Inc., Cupertino, CA (US)

(21) Appl. No.: 13/648,404

(22) Filed: Oct. 10, 2012

(51) Int. Cl. G02F 1/1335; G02F 1/1339

(52) U.S. Cl. CPC G02F 1/133512; G02F 1/133514; G02F 1/13394
USPC 349/106; 438/30

(57) ABSTRACT

An electronic device may be provided with a display mounted in a housing. The display may include a color filter layer, a liquid crystal layer, and a thin-film transistor layer. The color filter layer may form the outermost layer of the display. A color filter layer substrate in the color filter layer may have opposing inner and outer surfaces. A layer of patterned metal on the inner surface may form metal alignment marks. The metal alignment marks may include alignment marks for color filter elements, alignment marks for a black matrix layer that is formed on top of the color filter elements, and post spacer alignment marks. The layer of patterned metal may also form structures such as logo structures that are visible on the outer surface in an inactive border region of the display.

### BACKGROUND

This relates generally to electronic devices, and more particularly, to electronic devices with displays.

Electronic devices often include displays. For example, cellular telephones and portable computers often include displays for presenting information to a user.

It can be challenging to form displays for electronic devices. Displays such as liquid crystal displays typically include color filter layers for allowing the displays to display color images. Arrays of color filter element are formed on color filter layer substrates. If care is not taken, layers of material in a display such as the layers on a color filter layer substrate may be improperly aligned, may be overly complex to fabricate, or may exhibit performance shortcomings.

It would therefore be desirable to be able to provide improved displays for electronic devices.

### SUMMARY

An electronic device may be provided with a display mounted within a housing. The display may include a color filter layer, a liquid crystal layer, and a thin-film transistor layer. Other display layers such as layers associated with backlight structures may also be included in the display.

The color filter layer may form the outermost layer of the display. A color filter layer substrate in the color filter layer may have opposing inner and outer surfaces. The outer surface may be viewed by a user of the electronic device. The inner surface may face the liquid crystal layer.

A layer of patterned metal on the inner surface of the color filter layer may be used in forming metal alignment marks. The metal alignment marks may be used to ensure alignment between layers of material that are patterned on the inner surface and the color filter layer substrate.

The metal alignment marks may include alignment marks for color filter elements, alignment marks for a black matrix layer that is formed on top of the color filter elements, and post spacer alignment marks.

The layer of patterned metal may also form structures such as logo structures that are visible on the outer surface in an inactive border region of the display.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with a display in accordance with an embodiment of the present invention.

FIG. 2 is a perspective view of an illustrative electronic device such as a handheld electronic device with a display in accordance with an embodiment of the present invention.

FIG. 3 is a perspective view of an illustrative electronic device such as a tablet computer with a display in accordance with an embodiment of the present invention.

FIG. 4 is a perspective view of an illustrative electronic device such as a computer display with display structures in accordance with an embodiment of the present invention.

FIG. 5 is a cross-sectional side view of an illustrative display in accordance with an embodiment of the present invention.

FIG. 6 is a front view of an illustrative display showing an outer surface of a color filter layer in accordance with an embodiment of the present invention.

FIG. 7 is a cross-sectional side view of a color filter layer for a display in accordance with an embodiment of the present invention.

FIG. 8 shows the inner surface of an illustrative color filter layer having integrated logo and alignment mark structures in accordance with an embodiment of the present invention.

FIG. 9 is a cross-sectional side view of a portion of a color filter layer with alignment marks and an associated photolithographic mask with alignment marks that are aligned with the alignment marks on the color filter layer in accordance with an embodiment of the present invention.

FIG. 10 is a cross-sectional side view of the portion of the color filter layer of FIG. 9 following patterning of a layer of color filter material using the photolithographic mask in accordance with an embodiment of the present invention.

FIG. 11 shows a photolithographic mask and color filter layer during alignment operations in accordance with an embodiment of the present invention.

FIG. 12 shows the color filter layer of FIG. 11 following patterning of a layer of color filter material in the vicinity of the alignment marks in accordance with an embodiment of the present invention.

FIG. 13 is a cross-sectional side view of a portion of an illustrative color filter layer showing how alignment marks and logo structures may be formed from a layer of patterned metal in accordance with an embodiment of the present invention.

FIG. 14 is a cross-sectional side view of the illustrative color filter layer of FIG. 13 following formation of red color filter elements using red color filter element alignment marks in accordance with an embodiment of the present invention.

FIG. 15 is a cross-sectional side view of the illustrative color filter layer of FIG. 14 following formation of green color filter elements using green color filter element alignment marks in accordance with an embodiment of the present invention.

FIG. 16 is a cross-sectional side view of the illustrative color filter layer of FIG. 15 following formation of blue color filter elements using blue color filter element alignment marks in accordance with an embodiment of the present invention.

FIG. 17 is a cross-sectional side view of the illustrative color filter layer of FIG. 16 following formation of a patterned black masking layer on the red, green, and blue color filter elements using black masking layer alignment marks in accordance with an embodiment of the present invention.

FIG. 18 is a cross-sectional side view of the illustrative color filter layer of FIG. 17 following formation of post spacers using post spacer alignment marks in accordance with an embodiment of the present invention.

FIG. 19 is a flow chart of illustrative steps involved in forming a display with integrated metal alignment marks and logo structures in accordance with an embodiment of the present invention.

### DETAILED DESCRIPTION

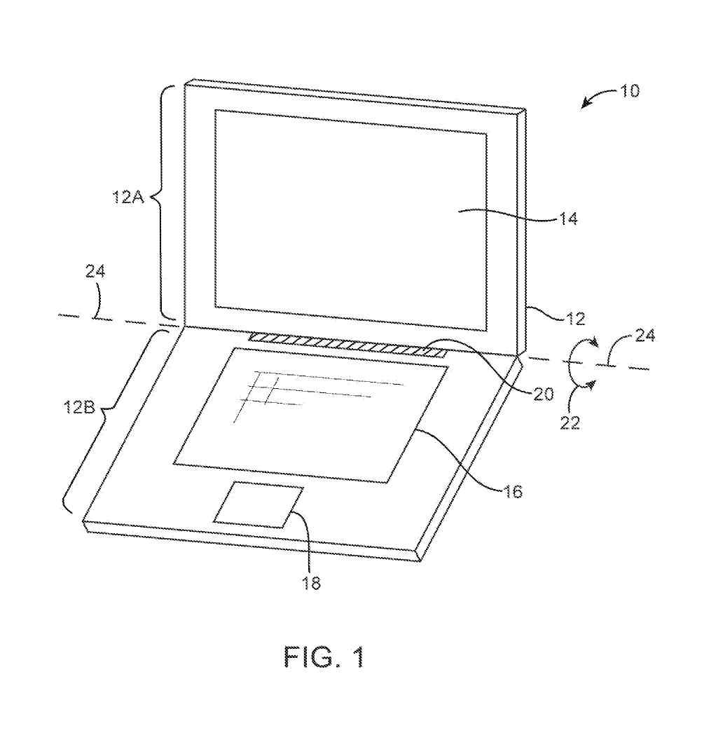

Electronic devices may include displays. The displays may be used to display images to a user. Illustrative electronic devices that may be provided with displays are shown in FIGS. 1, 2, 3, and 4.

FIG. 1 shows how electronic device 10 may have the shape of a laptop computer having upper housing 12A and lower housing 12B with components such as keyboard 16 and touchpad 18. Device 10 may have hinge structures 20 that allow upper housing 12A to rotate in directions 22 about rotational axis 24 relative to lower housing 12B. Display 14 may be mounted in upper housing 12A. Upper housing 12A, which may sometimes referred to as a display housing or lid, may be placed in a closed position by rotating upper housing 12A towards lower housing 12B about rotational axis 24.

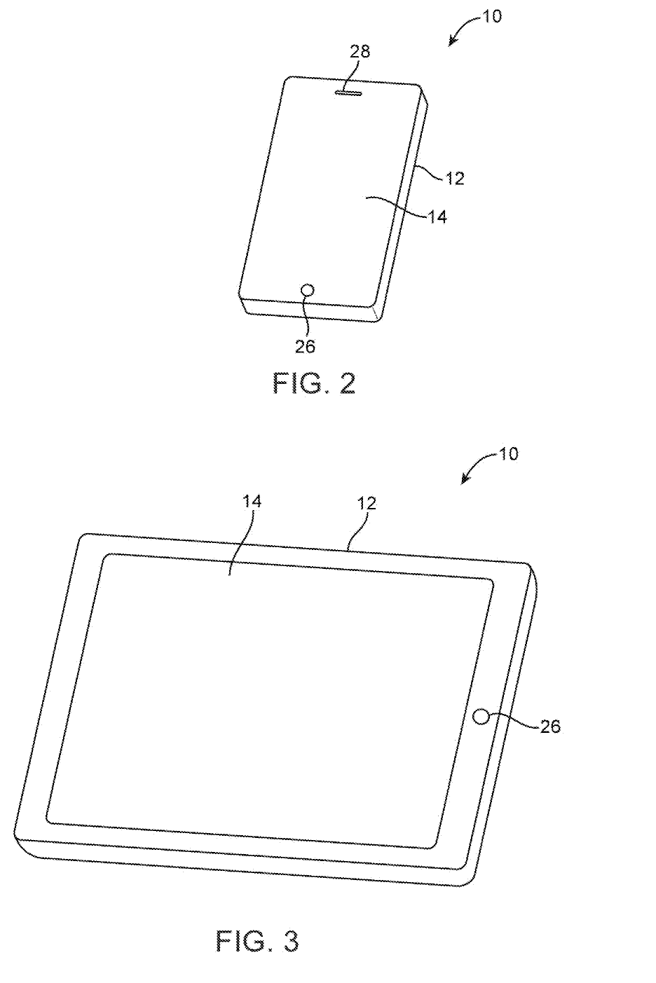

FIG. 2 shows how electronic device 10 may be a handheld device such as a cellular telephone, music player, gaming device, navigation unit, or other compact device. In this type of configuration for device 10, housing 12 may have opposing front and rear surfaces. Display 14 may be mounted on a front face of housing 12. Display 14 may, if desired, have openings for components such as button 26. Openings may also be formed in display 14 to accommodate a speaker port (see, e.g., speaker port 28 of FIG. 2).

FIG. 3 shows how electronic device 10 may be a tablet computer. In electronic device 10 of FIG. 3, housing 12 may have opposing planar front and rear surfaces. Display 14 may be mounted on the front surface of housing 12. As shown in FIG. 3, display 14 may have an opening to accommodate button 26 (as an example).

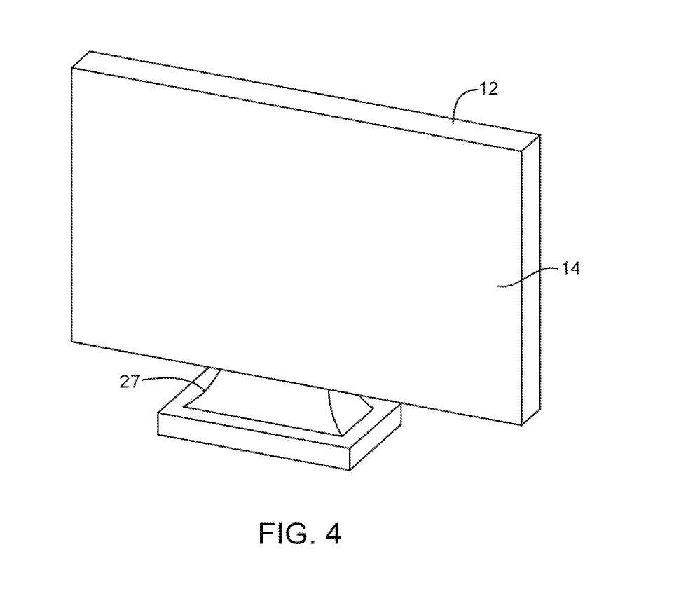

FIG. 4 shows how electronic device 10 may be a computer display or a computer that has been integrated into a computer display. With this type of arrangement, housing 12 for device 10 may be mounted on a support structure such as stand 27. Display 14 may be mounted on a front face of housing 12.

The illustrative configurations for device 10 that are shown in FIGS. 1, 2, 3, and 4 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

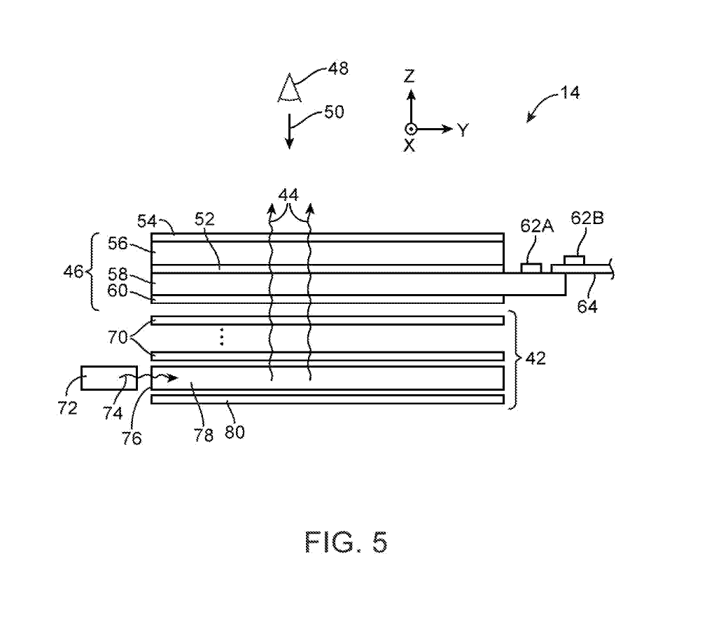

A cross-sectional side view of an illustrative configuration for display 14 of device 10 (e.g., for display 14 of the devices of FIG. 1, FIG. 2, FIG. 3, FIG. 4 or other suitable electronic devices) is shown in FIG. 5. As shown in FIG. 5, display 14 may include backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a configuration in which display layers 46 are used in forming a liquid crystal display, display layers 46 may include a liquid crystal layer such a liquid crystal layer 52. Liquid crystal layer 52 may be sandwiched between display layers such as display layers 58 and 56. Layers 56 and 58 may be interposed between lower polarizer layer 60 and upper polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry (e.g., one or more integrated circuits on a printed circuit) may be used to generate information to be displayed on display 14 (e.g., display data). The information to be displayed may be conveyed to a display driver integrated circuit such as circuit 62A or 62B using a signal path such as a signal path formed from conductive metal traces in a rigid or flexible printed circuit such as printed circuit 64 (as an example).

Backlight structures 42 may include a light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed in dimensions X and Y throughout light guide plate 78 due to the principal of total internal reflection. Light guide plate 78 may include light-scattering features such as pits or bumps. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 5, optical films 70 and reflector 80 may have a matching rectangular footprint.

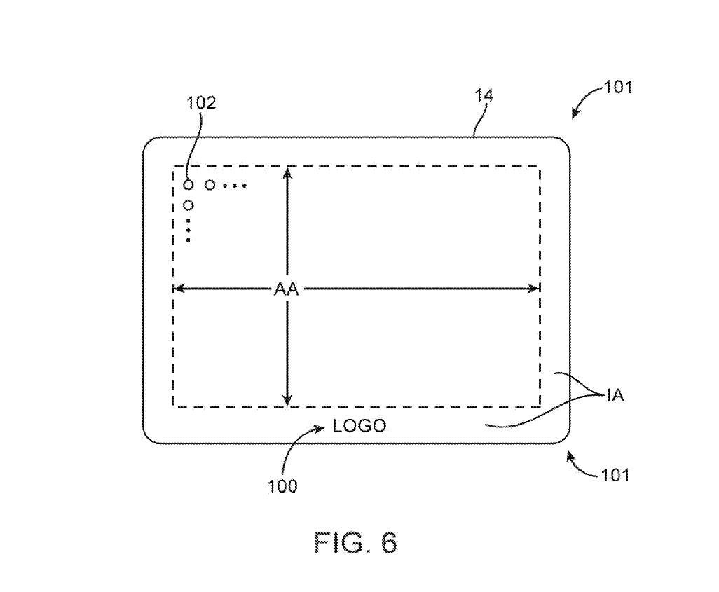

As shown in FIG. 6, display 14 may be characterized by an active area such as active area AA. Active area AA may include an array of display pixels 102. Display pixels 102 may be used in displaying images to viewer 48 during operation of device 10. An inactive border region such as inactive area IA may surround the periphery of active area AA. For example, in a configuration of the type shown in FIG. 6 in which active area AA has a rectangular shape surrounded by four peripheral edges, inactive region IA may have the shape of a rectangular ring that runs along each of the four peripheral edges of active area AA and thereby surrounds active area AA. Corners 101 of the layers in display 14 such as the corners of thin-film-transistor layer 58 and color filter layer 56 may be rounded (e.g., to fit within matching rounded corners of housing 12).

Logo structures such as illustrative logo 100 of FIG. 6 or other structures may be formed in portions of display 14 such as inactive area IA. Structures 100 may, for example, be formed from patterned metal on the inner surface of a glass or plastic layer in display 14 so as to be visible to a user of device 10. Logo structures 100 may be formed in an inactive border region of display 14 such as on the lower edge of display 14 as shown in FIG. 6 and/or on other edges of display 14 (e.g., a top edge, a left edge, and/or a right edge). Structures 100 may include characters such as letters and other text, may include graphical elements (e.g., stylized shapes for logos), may include one or more logos, or may include other decorative or informative elements. Configurations for display 14 that include a logo such as the logo of structures 100 of FIG. 6 are sometimes described herein as an example.

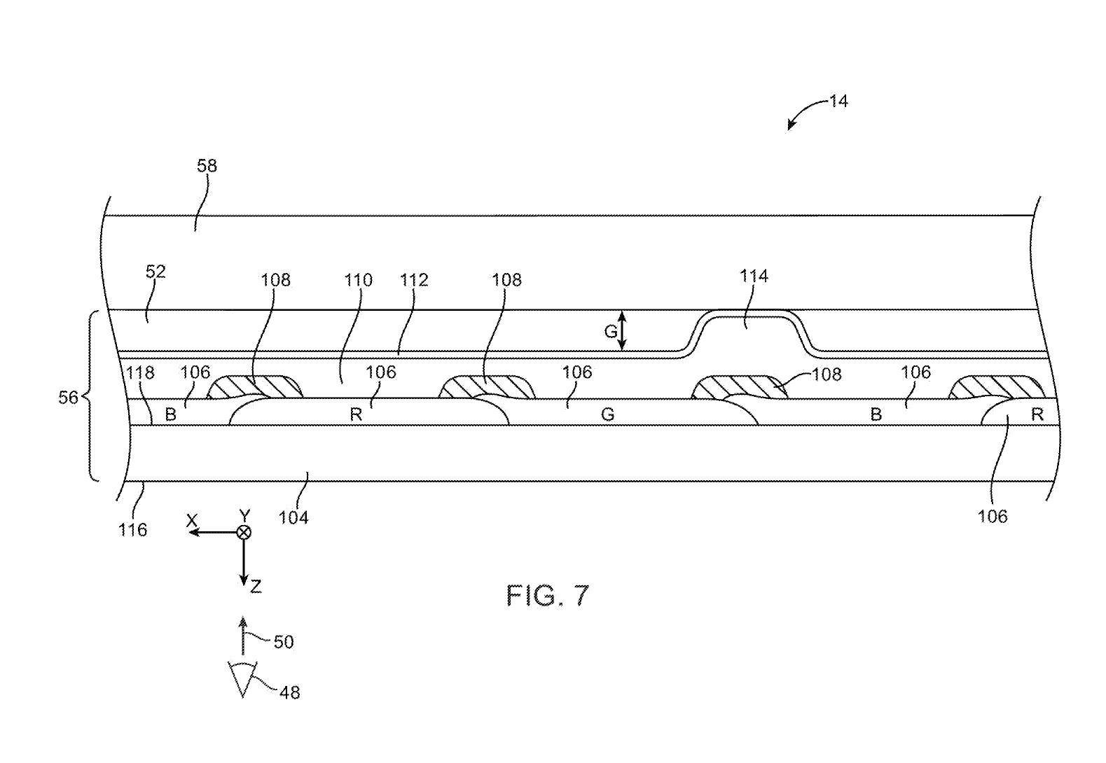

Structures such as logo 100 may be formed (in reverse) on the inner surface of a layer in display 14 such as color filter layer 56. A cross-sectional side view of a portion of display 14 showing how color filter layer 56 may include a substrate layer covered with color filter elements is shown in FIG. 7. As shown in FIG. 7, display 14 may include a color filter layer such as color filter layer 56 and a thin-film-transistor layer such as layer 58. Layer 58 may include a substrate such as a glass or plastic substrate covered with thin-film transistor circuitry. Liquid crystal layer 52 may be interposed between color filter layer 56 and thin-film transistor layer 58.

Color filter layer 56 may have a substrate layer such as substrate 104. Substrate 104 may be formed from a sheet of glass, plastic, or other transparent dielectric. Substrate 104 may have an outer surface such as surface 116 facing viewer 48 and an inner surface such as surface 118. An array of color filter elements 106 may be formed on inner surface 118 (e.g., in a rectangular array shape having rows and columns associated with respective rows and columns of display pixels 102). Color filter elements 106 may include, for example, red color filter elements R, green color filter elements G, and blue color filter elements B. The array of color filter elements in color filter layer 56 may be used to provide display 14 with the ability to display color images.

Opaque masking material 108 may be formed on top of color filter elements 106. Opaque masking material 108 may be formed from a dark substance such as a polymer that contains a black pigment and may therefore sometimes be referred to as a black mask, black masking layer, black pigmented layer, or black masking material. Illustrative polymeric materials for forming black masking layer 108 include acrylic-based and polyimide-based photoresists. An illustrative black pigment that may be used for black masking layer 108 is amorphous carbon (carbon black).

Black mask 108 may be patterned to form a grid of relatively thin lines (sometimes referred to as a black matrix) on top of color filter elements 108 in active area AA. The black matrix may have an array of rectangular openings bordered by the thin lines. The openings in the black matrix may overlap respective color filter elements 106 to help optically delineate the separation between adjacent color filter elements and thereby reduce color bleeding effects. Portions of color filter elements 106 that are aligned with display pixels 102 (FIG. 6) may be free of black mask 108 so that light such as backlight 44 (FIG. 5) may pass through color filter layer 56.

Placing opaque masking material 108 above the layer of color filter element on substrate 104 as shown in FIG. 7 may help to reduce off-axis light leakage more than configurations in which opaque masking material 108 is formed directly on surface 118 between adjacent color filter elements. Configurations for display 14 in which black matrix 108 is formed on top of color filter elements 106 are therefore sometimes described herein as an example.

To ensure that photolithographic processing operations are performed satisfactorily when patterning the structures of color filter layer 56, alignment marks may be formed on surface 118.

In inactive region IA, black masking material such as the material of structures 108 in FIG. 7 may be used in forming a peripheral opaque mask that serves as an opaque border for display 14. The opaque mask in inactive area IA may have a rectangular ring shape that surrounds central rectangular active area AA (as an example).

Display 14 may include layers on outer surface 116 of substrate 104 or on a display cover layer. These layers, which may sometimes be referred to as coatings, may include layers such as polarization structures, layers for reducing fingerprints (e.g., a smudge-resistant coating in a touch-sensitive display), anti-scratch coatings, antireflection coatings, one or more shielding layers for reducing the impact of static electricity such as an indium tin oxide electrostatic discharge protection layer, or other layers of material.

Layers of material such as color filter material (e.g., red color filter material, green color filter material, and blue color filter material) may be deposited on inner surface 118 of color filter layer substrate 104. Black masking material 108 may be deposited on color filter elements 106. Color filter material and black masking material may be deposited by screen printing, spin-on coating, spray coating, physical vapor deposition, chemical vapor deposition, or other suitable deposition techniques. Photosensitive materials may be used for elements 106 and structures 108. Photolithographic patterning techniques may be used in patterning photosensitive layers.

Color filter elements 106 of each color (e.g., red R, green G, and blue G) may be formed by depositing color filter material of that color on inner surface 118 (and over any previously deposited and/or patterned materials) and by etching or otherwise patterning (e.g., using photolithographic equipment) the color filter material of that color to form the color filter elements. Photolithographic patterning may also be used in forming black mask 108. Following formation of elements 106 and black mask 108, overcoat layer 110 may be formed. Overcoat layer 110 may be formed from a clear polymer such as acrylic. Layer 110 may be used as a blocking layer to prevent impurities from color filter elements 106 from reaching liquid crystal layer 52. Layer 110 may also serve as a planarization layer.

Post spacer structures such as post spacers 114 may be patterned onto the surface of layer 110 (e.g., using photolithography). Post spacers 114 may be formed from a material such as metal and may be used to establish desired size for gap G between thin-film transistor layer 58 and color filter layer 56. A roller printed liquid crystal alignment layer of polyimide or other suitable material such as layer 112 may be formed on top of post spacers 114 and overcoat 110. When assembled to form display 14 as shown in FIG. 7, post spacers 114 will prevent thin-film-transistor layer 58 from coming into contact with color filter layer 56.

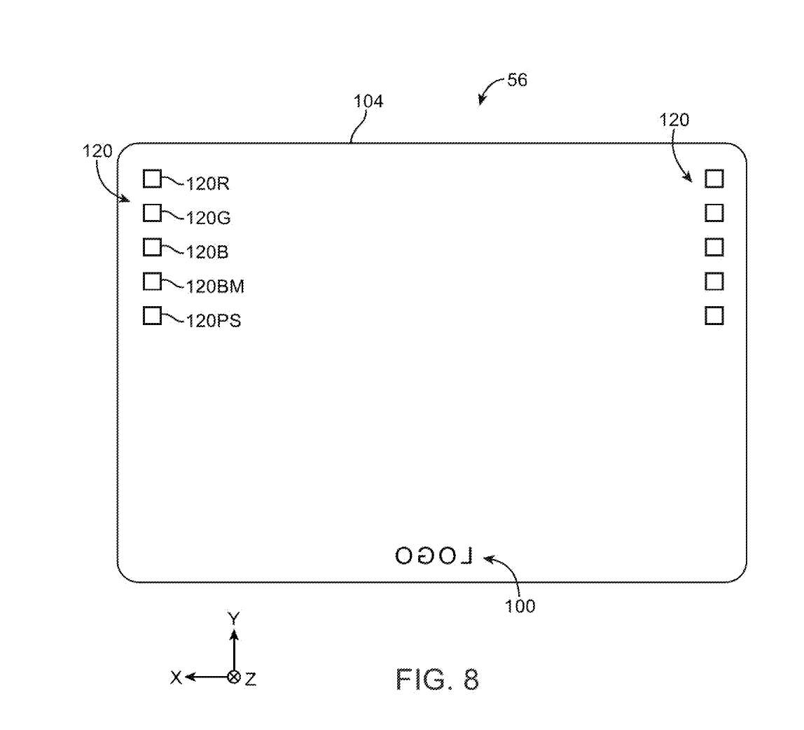

A view of color filter layer 56 from the interior of display 14 is shown in FIG. 8. As shown in FIG. 8, logo 100 may be formed in reverse in the lower portion of substrate 104. By forming logo 100 (or other text or design) in mirror image form (i.e., in reverse from its intended orientation), logo 100 (or other text or design) will be properly oriented when viewed by viewer 48 in direction 50 from the front of display 14 (i.e., by forming the text of logo 100 in reverse on the inside of color filter layer 56, the text will be properly oriented and readable to a viewer external to the display as visible text on the outer surface of the color filter layer). Logo 100 may be formed from metal or other suitable material.

Alignment structures such as alignment marks 120 may be formed from metal or other suitable material. As an example, alignment mark structures 120 and structures such as logo 100 may be formed as different portions of the same patterned layer of metal. The patterned layer of metal may be a layer of chromium, a multilayer stack formed from a layer of aluminum capped with a layer of molybdenum, a multilayer stack formed from a layer of aluminum capped with a layer of titanium, a layer of molybdenum, a layer of titanium, a layer of copper, a layer of aluminum coated with optional clear protective dielectric coatings such as silicon dioxide or silicon nitride coatings, a layer of copper, or other metal. When fabricating displays such as display 14 from a common large panel, it may be desirable to divide the panel into smaller displays using scribe-and-break techniques. A scribing tool may be used to form scribe lines in a layer of display glass. Color filter layers such as color filer layer 56 can then be separated from the larger display panel by breaking the panel along the scribe lines. Alignment marks 120 may be formed inside or outside of the rectangular color filter layer area formed by the scribe lines.

By forming alignment structures 120 from a shiny material such as metal, structures 120 may be visible during manufacturing, even when covered by dark layers of material such as the layer of material used in forming black mask 108 or other layers of material that are not highly transparent. To ensure that the layers of material that are deposited on substrate 104 during fabrication of color filter layer 56 do not interfere with the alignment marks, alignment marks 120 may include separate sets of alignment marks for each of the layers of colored or opaque material in FIG. 7.

For example, a set of five alignment marks may be included in each cluster of marks 120. The set of alignment marks may include red-layer metal alignment marks 120R for aligning a red-layer photolithographic mask with respect to substrate 104 when patterning red color filter elements 106, green-layer metal alignment marks 120G for aligning a green-layer photolithographic mask with respect to substrate 104 when patterning green color filter elements 106, blue-layer metal alignment marks 120B for aligning a blue-layer photolithographic mask with respect to substrate 104 when patterning blue color filter elements 106, black-mask-layer metal alignment marks 120BM for aligning a black-mask-layer photolithographic mask with respect to substrate 104 when patterning black mask 108, and post-spacer-layer metal alignment marks 120PS for aligning a post-spacer-layer photolithographic mask with respect to substrate 104 when patterning post spacers 114.

In the example of FIG. 8, two sets of metal alignment marks 120 have been formed on the left and right edges of substrate 104, respectively. This is merely illustrative. Other alignment mark configurations may be used, if desired.

FIG. 9 is a cross-sectional side view of color filter layer 56 during fabrication. In the scenario illustrated in FIG. 9, alignment marks 120R have been formed on surface 118 of substrate 104. A photosensitive material such as red photoresist 132 has been deposited on surface 118 of substrate 118 over alignment marks 120R. Red photoresist 132 may be, for example, negative photoresist (i.e., photoresist that remains on substrate 104 where exposed to light and that is removed during development where unexposed to light).

Photolithographic mask 130 has corresponding alignment marks such as alignment mark 122 on mask substrate 124. During mask alignment operations, a mask aligner or other equipment may be used to adjust the position of mask 130 laterally (i.e., in directions 136) so that alignment mark 122 is centered with respect to alignment mark 120R of FIG. 9, thereby aligning mask 130 with respect to color filter substrate 104. Mask 130 may contain a pattern for forming an array of red color filter elements in active area AA of display 14, so aligning mask 130 with respect to substrate 104 will ensure that the red color filter elements are formed in appropriate locations and will be aligned with the other color filter elements (i.e., blue and green color filter elements) and with black mask and post spacer features.

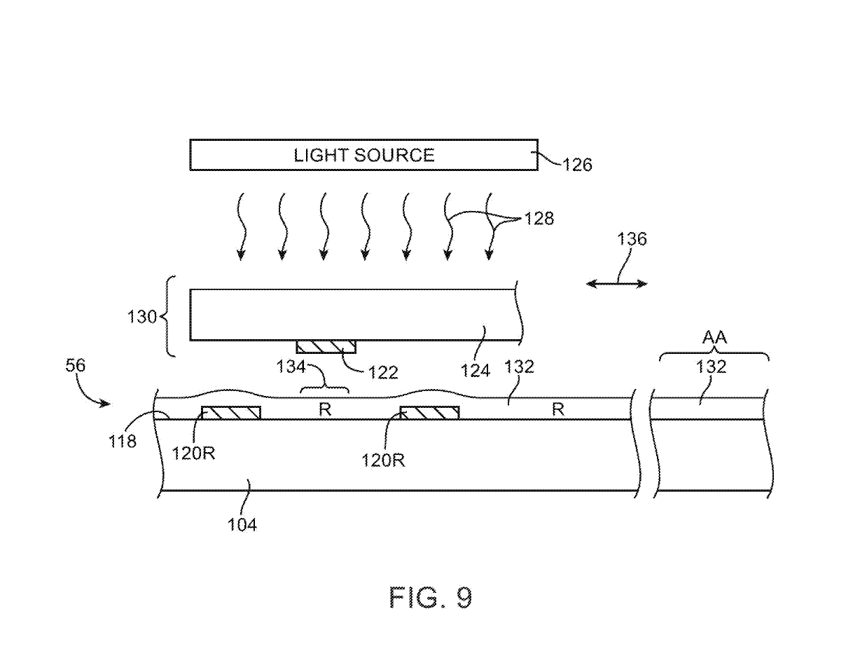

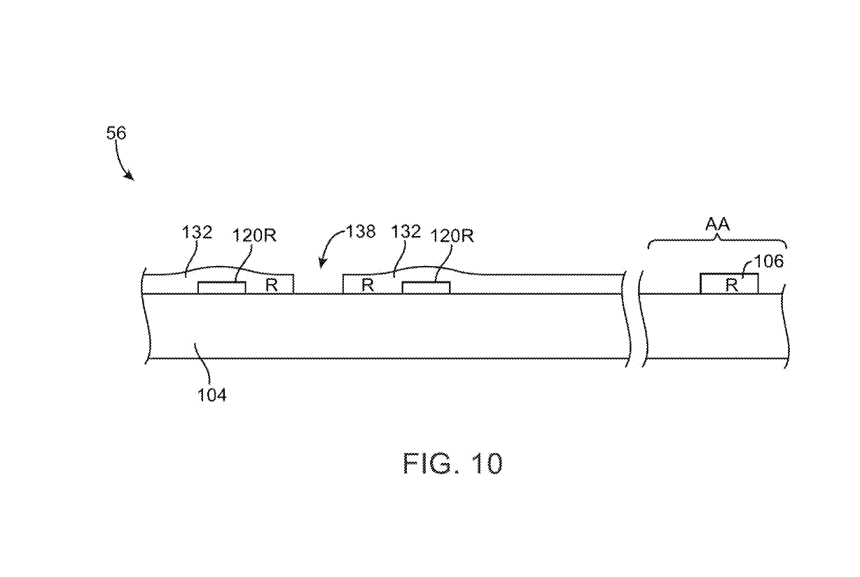

Alignment marks such as mark 122 of FIG. 9 may be formed from a metal such as chromium. Substrate 124 may be formed from a clear material such as fused quartz. Light for exposing photosensitive layer 132 on the surface of substrate 104 may be produced by light source 126. Light source 126 may be a lamp or laser such as an ultraviolet light lamp or laser. Light source 126 may produce light 128 that travels through mask 130. When traveling through mask 130, metal 122 will locally block light 128, so that patterned light illuminates photosensitive red layer 132. In the portion of layer 56 that is shown in FIG. 9, alignment mark 122 in mask 130 blocks light 128 from reaching region 134 of photosensitive red layer 132. As a result, the portion of photosensitive red layer 132 that lies within region 134 will be removed following development in a developer to form opening 138, as shown in FIG. 10. In active area AA of display 14, the pattern of metal on photolithographic mask 130 may define an array of color filter elements 106 (e.g., red color filter elements 106), as shown on the right side of FIG. 10.

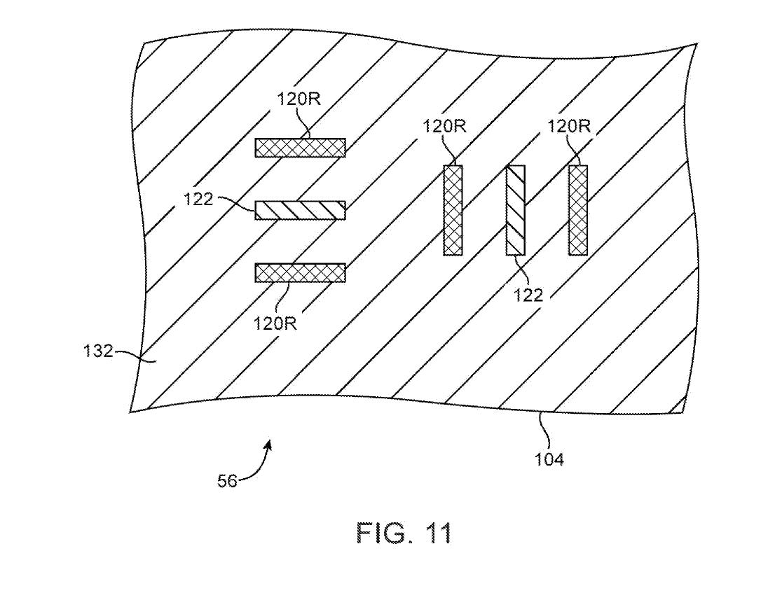

FIG. 11 is a top view of mask 130 in alignment with the color filter layer structures of FIG. 9. As shown in FIG. 11, photolithographic mask alignment marks 122 are centered and therefore in alignment relative to red color filter layer alignment marks 120R. Although red photoresist layer 132 covers the surface of substrate 104 and therefore covers alignment marks 120R, alignment marks 120R are formed from metal and are therefore sufficiently shiny to be readily visible through layer 132 (which is colored by not completely opaque). Accordingly, an operator of the mask aligner or other equipment being used to position mask 130 relative to substrate 104 can position mask 130 in alignment with alignment marks 120R.

Following exposure through the photolithographic mask (and associated alignment marks 122 of FIG. 11), red photoresist layer 132 may be developed to leave openings such as openings 138 of FIG. 12 while forming an array of red color filter elements 106 in active area AA. The use of metal alignment marks 120 allows the alignment marks to be viewed through the layers of material that are deposited over the marks, including dark layers such as a black masking layer.

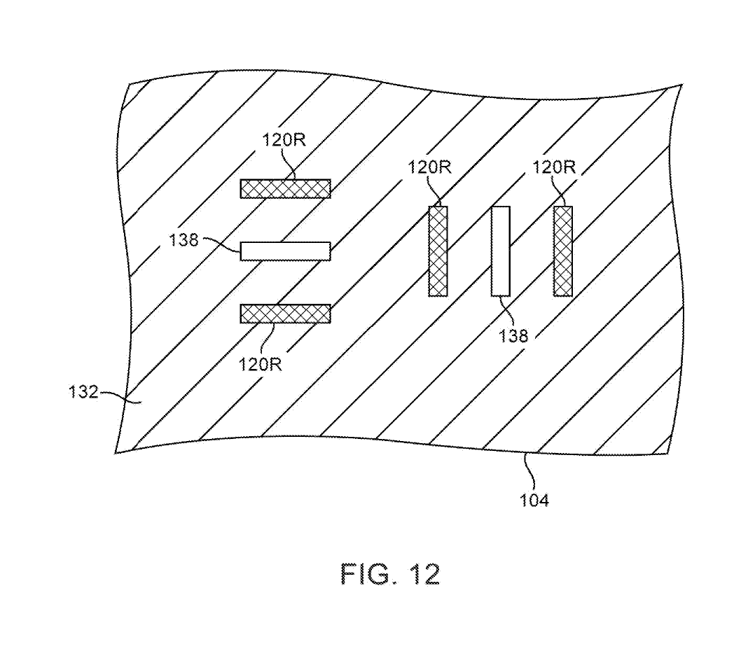

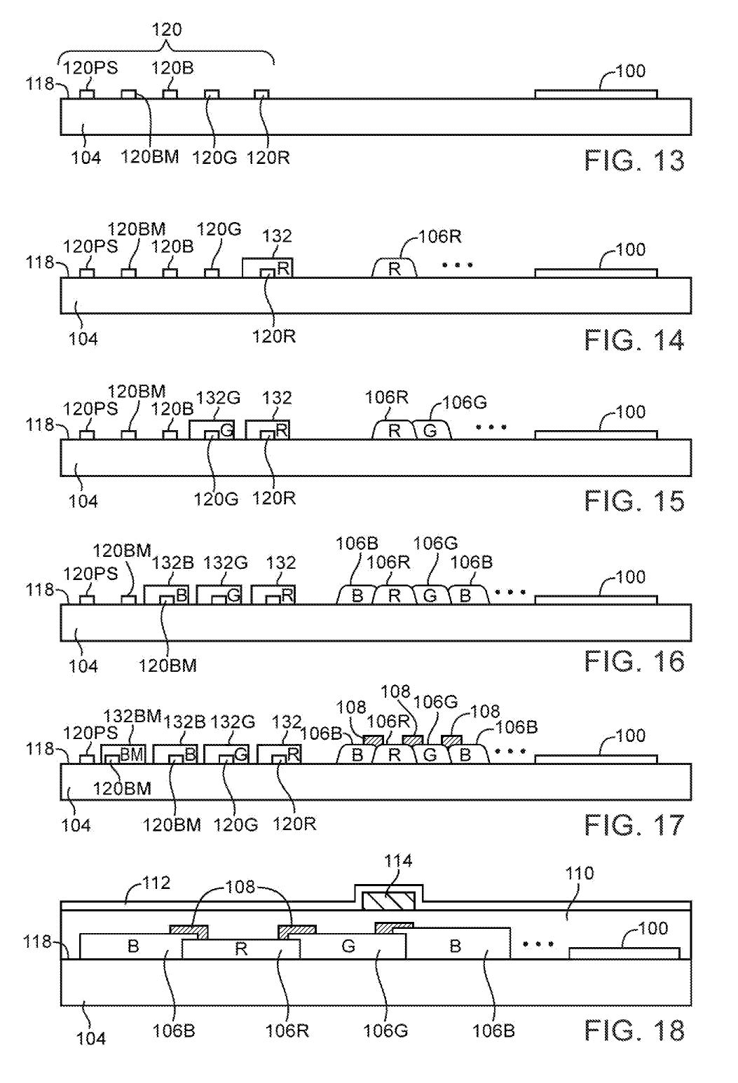

Subsequent layers of material may be patterned on substrate 104 using additional masks, as described further in connection with FIGS. 13-18.

FIG. 13 is a cross-sectional side view of an illustrative configuration for color filter layer 56 after alignment marks 120 and structures 100 such as logo structures or patterned decorative structures or other structures have been simultaneously formed on surface 118 of substrate 104 (e.g., by depositing a blanket metal film using physical vapor deposition and photolithographically patterning the deposited metal film to form the metal structures of FIG. 13 such as alignment marks 120 and structures 100). Alignment mark structures 120 may include red-layer metal alignment mark structures 120R for aligning a red-layer photolithographic mask with respect to substrate 104 when forming red color filter elements, green-layer metal alignment mark structures 120G for aligning a green-layer photolithographic mask with respect to substrate 104 when forming green color filter elements, blue-layer metal alignment mark structures 120B for aligning a blue-layer photolithographic mask with respect to substrate 104 when forming blue color filter elements, black-mask-layer metal alignment mark structures 120BM for aligning a black-mask-layer photolithographic mask with respect to substrate 104 when forming black mask 108, and post-spacer-layer metal alignment mark structures 120PS for aligning a post-spacer-layer photolithographic mask with respect to substrate 104 when forming post spacers 114.

Red, green, and blue color filter elements can be formed using marks 120R, 120G, and 120B. Initially, a layer of red photoresist (color filter material) may be patterned on substrate 104 using alignment marks 120R, thereby forming an array of red color filter elements 106R in alignment with substrate 104, as shown in FIG. 14. Red color filter material 132 may cover alignment marks 120R following patterning of color filter elements 106R, but other alignment marks 120 may remain free of photoresist.

After forming red color filter elements 106R, an array of green color filter elements 106G may be formed in alignment with substrate 104 and therefore in alignment with red color filter elements 106R, as shown in FIG. 15. In forming green color filter elements 106G, a photolithographic mask for the green color filter element structures may be aligned with respect to green-layer color filter element alignment mark structures 120G. Green color filter material 132G may cover alignment marks 120G following patterning of color filter elements 106G.

After forming red color filter elements 106R and green color filter elements 106G, an array of blue color filter elements 106B may be formed in alignment with substrate 104 and therefore in alignment with red color filter elements 106R and green color filter elements 106G, as shown in FIG. 16. In forming blue color filter elements 106B, a photolithographic mask for the blue color filter element structures may be aligned with respect to blue-layer color filter element alignment mark structures 120B. As shown in FIG. 16, blue color filter material 132B may cover alignment marks 120B after patterning color filter elements 106B.

Once an array of red, blue, and green color filter elements 106 has been formed, black mask 108 (i.e., a grid-shaped black matrix) may be formed on color elements 106 using metal alignment mark structures 120BM for alignment. Black mask material 132BM may cover alignment structures 120BM during the alignment process and after patterning, as shown in FIG. 17. Even though black mask material covers alignment mark structures 120BM during the alignment process, the shiny nature of metal structures 120BM makes structures 120BM visible to the mask aligner and thereby allows the photolithographic mask for black mask structures 108 to be aligned with respect to the structures 120BM.

After patterning black mask 108 on color filter elements 106, post spacer alignment mark structures 120PS can be used to fabricate post spacer structures 114 in alignment with substrate 104, color filter elements 106, and black mask 108, as shown in FIG. 18. Overcoat 110, which is formed over color filter elements 106 and black mask 108 before fabricating post spacers 114 may be formed from a clear polymer. A liquid crystal alignment layer of polyimide or other suitable material such as layer 112 may be formed on top of post spacers 114 and overcoat 110.

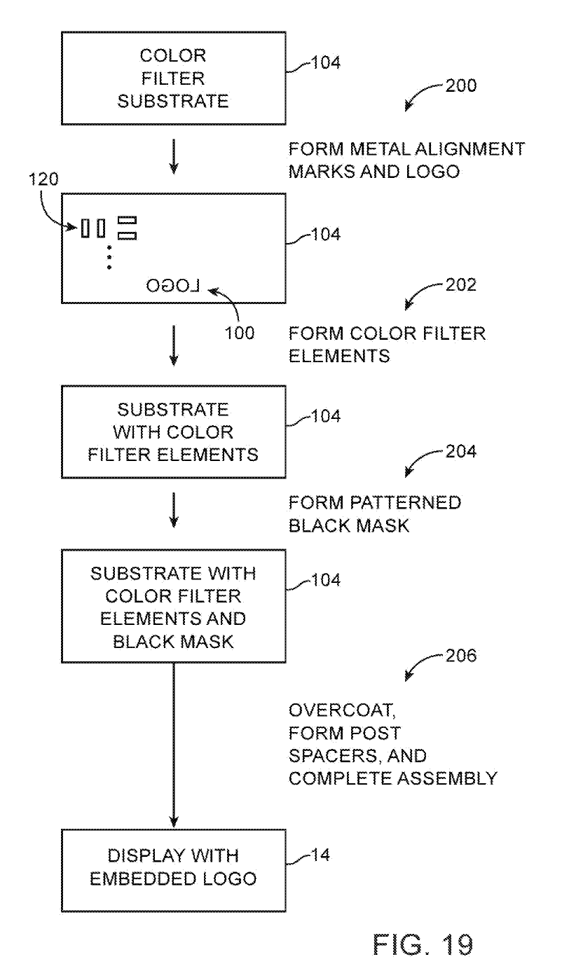

Illustrative steps involved in forming device 10 and display 14 with logo structures or other metal structures 100 and metal alignment structures 120 of the type shown in FIGS. 13-18 are shown in FIG. 19.

At step 200, a blank color filter substrate such as substrate 104 may be provided with alignment marks 120 and structures 100. Substrate 104 may be, for example, a layer of clear glass, a transparent plastic layer, or other transparent substrate. Alignment marks 120 may be formed along one or more of the edges of substrate 104. Alignment marks 120 may include individual alignment marks for each of the respective layers of FIGS. 13-18 including marks for red color filter elements, green color filter elements, blue color filer elements, black mask structures, and post spacers. Structures 100 that are formed during the operations of step 200 may include a logo, text, decorative patterns, or other structures. Structures 100 and alignment marks 104 may be formed on inner surface 118 of substrate 104 (e.g., in the inactive border of display 14). Accordingly, structures 100 may be fabricated using a mirror image of the desired visible pattern for structures 100 when viewed in direction 50 from the exterior of device 10 by viewer 48.

Alignment marks 120 and structures 100 may be formed from a material such as metal. Metal alignment marks exhibit satisfactory visibility through dark material layers such as black mask photoresist during fabrication. Metal is also sufficiently shiny to create readily visible logos or other structures 100. During step 200, alignment marks 120 and structures 100 are preferably formed using the same metal patterning operations. For example, a blanket metal layer for both alignment marks 120 and structures 100 may be deposited using physical vapor deposition equipment or other suitable metal deposition equipment. The metal layer may then be patterned to form alignment marks 120 and structures 100 using a common layer of photoresist, a common photolithographic mask, and common development and etching operations. By forming alignment marks 120 and structures 100 from a common layer of metal, the number of masks and fabrication operations used in forming display 14 may be minimized.

After forming alignment marks 120 and structures 100 on substrate 104, additional processing steps may be used to form color filter elements 106 (step 202). During the operations of step 202, alignment marks such as red-layer alignment marks 120R, green-layer alignment marks 120G, and blue-layer alignment marks 120B may be used in forming an array of color filter elements on substrate 106.

At step 204, black mask 108 may be deposited and patterned on top of the array of color filter elements. In forming the black mask layer, alignment marks 120BS may be used to ensure that the grid lines in the black matrix pattern are aligned with respect to substrate 104 and the color filter elements. Portions of black mask 108 may cover inactive border region IA (FIG. 6), so that display 14 is provided with a dark border. Structures 100 are formed on surface 118 under this black masking material and are therefore visible on outer surface 116.

Once the black matrix has been formed over the color filter elements, the operations of step 206 may be performed to form overcoat 110, post spacers 114, and layer 112. Color filter layer 56 may then be assembled with liquid crystal layer 52 and thin-film transistor layer 58 and the other display layers of display 14 (FIG. 5) to form display 14. Display 14 may be mounted within housing 12 to form device 10. When operated by a user, device 10 can present images on display 14 while the user views visible structures 100 such as a logo in an inactive portion of display 14.

The foregoing is merely illustrative of the principles of this invention and various modifications can be made by those skilled in the art without departing from the scope and spirit of the invention.

What is claimed is:

1. A display with an active area and an inactive border, comprising:
a color filter layer having a color filter layer substrate with an inner surface and an opposing outer surface and having visible metal structures on the inner surface within the inactive border that are visible on the outer surface.

2. The display defined in claim 1 wherein the visible metal structures comprise a logo.

3. The display defined in claim 1 further comprising alignment marks on the inner surface.

4. The display defined in claim 3 wherein the alignment marks and the visible metal structures are part of a common layer of patterned metal on the inner surface.

5. The display defined in claim 1 further comprising:
a thin-film-transistor layer; and
a layer of liquid crystal material interposed between the thin-film-transistor layer and the color filter layer.

6. The display defined in claim 1 wherein the color filter layer comprises:
an array of color filter elements on the inner surface; and
a black matrix on the color filter elements.

7. The display defined in claim 6 further comprising alignment marks on the inner surface, wherein the alignment marks include metal black matrix alignment marks to align the black matrix with respect to the color filter elements.

8. The display defined in claim 7 wherein the alignment marks and the visible metal structures are part of a common layer of patterned metal on the inner surface.

9. The display defined in claim 8 further comprising:
a thin-film-transistor layer; and
a layer of liquid crystal material interposed between the thin-film-transistor layer and the color filter layer.

10. The display defined in claim 9 wherein the alignment marks include metal post spacer alignment marks and wherein the color filter layer further comprises post spacers that are aligned with the metal post spacer alignment marks.

11. The display defined in claim 10 wherein the alignment marks include metal red-color-filter-layer alignment marks, metal blue-color-filter-layer alignment marks that are separate from the metal red-color-filter-layer alignment marks, and metal green-color-filter-layer alignment marks that are separate from the metal red-color-filter-layer alignment marks and the metal blue-color-filter-layer alignment marks.

12. The display defined in claim 11 wherein the visible metal structures comprise a logo.

13. The display defined in claim 12 wherein the logo includes text formed in reverse on the inner surface so as to be readable by a viewer on the outer surface.

14. A display, comprising:
a color filter layer having a color filter layer substrate with an inner surface and an opposing outer surface;
a thin-film-transistor layer; and
a layer of liquid crystal material between the color filter layer and the thin-film-transistor layer, wherein the color filter layer includes metal alignment marks on the inner surface, an array of color filter elements on the inner surface, and a black matrix formed on the color filter elements.

15. The display defined in claim 14 further comprising metal structures on the inner surface that are visible on the outer surface.

16. The display defined in claim 15 wherein the metal structures and the metal alignment marks form parts of a common patterned metal layer on the inner surface.

17. The display defined in claim 16 wherein the metal alignment marks include a black-mask-layer metal alignment mark that is aligned with the black matrix.

18. The display defined in claim 17 wherein the black matrix comprises a polymer with black pigment, wherein the color filter layer includes an overcoat over the black matrix, wherein the color filter layer further comprises metal post spacers on the overcoat, and wherein the alignment marks include metal post spacer alignment marks.

19. A display with an active area and an inactive border, comprising:
a color filter layer having a color filter layer substrate with an inner surface and an opposing outer surface; and
a thin-film-transistor layer; and
a layer of liquid crystal material between the color filter layer and the thin-film-transistor layer, wherein the color filter layer includes metal structures visible on the outer surface and includes metal alignment marks and wherein the metal structures and the metal alignment marks are formed from portions of a common metal layer on the inner surface.

20. The display defined in claim 19 wherein the color filter layer comprises an array of color filter elements on the inner surface in the active area and comprises a black matrix formed on the color filter elements so that portions of the color filter elements are interposed between the black matrix and the inner surface.

21. A method of forming a display with an active area and an inactive border, comprising:
forming a color filter layer having a color filter layer substrate with an inner surface and an opposing outer surface, wherein forming the color filter layer includes forming metal structures and metal alignment marks from portions of a common metal layer on the inner surface so that the metal structures are visible on the outer surface;
forming a thin-film-transistor layer; and
forming the display by interposing a layer of liquid crystal material between at least a portion of the color filter layer and the thin-film-transistor layer.

22. The method defined in claim 21 wherein forming the color filter layer comprises forming an array of color filter elements on the inner surface in the active area and forming a black matrix on the color filter elements so that portions of the color filter elements are interposed between the black matrix and the inner surface.
